(19) United States
(12) Patent Application Publication
(10) Pub. No.: US 2012/0304062 A1
(43) Pub. Date: Nov. 29, 2012

(54) REFERENCING CONTENT VIA TEXT CAPTIONS

(75) Inventors: Daniel Schultz, Somerville, MA (US); Matthew Mireles, San Francisco, CA (US); Tyler Kieft, San Francisco, CA (US)

(73) Assignee: SPEAKERTEXT, INC., Mountain View, CA (US)

(21) Appl. No.: 13/113,182

(22) Filed: May 23, 2011

(51) Int. Cl. G06F 3/01

(52) U.S. Cl. 715/716

(57) ABSTRACT

Improved techniques involve copying text occupying, within a browser application, a selected portion of a transcript associated with the content and, in response to the copying, augmenting the copied text with a direct link to the particular video frame from which particular spoken text begins within the video content. The particular spoken text begins within a particular text caption which corresponds to a timestamp, and the beginning of the copied text occupies the particular text caption. The augmenting of the copied text occurs before the copied text is placed within a buffer in memory reserved for copied data. The contents of the buffer then include the copied text and the direct link to the particular video frame.

### BACKGROUND

Conventional transcription applications reference digital video by accompanied spoken words. Such an application provides, within a web browser window, a textual transcript which corresponds to the spoken words of the digital video. As a digital player in the web browser window plays the digital video, an application highlights text in the transcript which corresponds to particular spoken words. For example, an application highlights each sentence in the transcript as the sentence is spoken within the digital video.

In addition, conventional transcription applications play digital video in the digital player from a place which corresponds to a particular sentence of the text in the transcript. For example, such an application provides a Custom Quote button which accompanies the transcript and the digital player within the web browser window. The Custom Quote button places, into a location in memory, selected text within the transcript, a timestamp and a Uniform Resource Locator (URL) link. When a user switches to another application such as a word processor or an email editor and calls an insertion command, the application inserts the text from the location in memory and embeds, in the text, a hyperlink which points to the URL link. When the user clicks on the inserted text, a new browser window which contains a digital player opens with the digital player playing the digital video from the point where the words corresponding to the selected sentence are spoken.

### SUMMARY

Improved techniques involve invoking, within an application which supports a copy command, the copy command after selecting text in a transcript associated with video content. In response to the copy command, the application augments the selected text with a marker which corresponds, within the video content, to a particular video frame from which particular spoken text begins. The augmenting of the selected text occurs before the selected text is placed within a buffer in memory reserved for copied data. The contents of the buffer then include the selected text and the marker. The application further generates a URL link to a browser window containing a video player which is operable to play the video content starting at a particular location determined by the marker. Upon the issuing of a subsequent paste command within a content destination which includes a rich text environment, the selected text is pasted into the rich text environment. The pasted text includes a hyperlink which, when activated by clicking on the pasted text, launches a new browser window according to the URL link.

One embodiment of the improved techniques is directed to a method of identifying a starting point from which to render content in a content delivery session. The method includes receiving user input by a processing circuit while running an application on the processing circuit, the application being constructed and arranged to copy selected content portions from content sources to a buffer for pasting to content destinations in response to copy commands, the user input selecting a content portion from a content source. The method also includes receiving a copy command while the content portion is selected. The method further includes, in response to receipt of the copy command, forming augmented content which includes the selected content portion and a marker and copying the augmented content to the buffer for pasting to a content destination, the marker identifying the starting point from which to render content in the content delivery session.

Additionally, some embodiments of the improved technique are directed to a device configured to identify a starting point from which to render content in a content delivery session. The device includes a memory including a buffer and a controller which includes controlling circuitry coupled to the memory. The controlling circuitry is configured to carry out the method of identifying a starting point from which to render content in a content delivery session.

Furthermore, some embodiments of the improved technique are directed to a computer program product having a non-transitory computer readable storage medium which stores code including a set of instructions to carry out the method of identifying a starting point from which to render content in a content delivery session.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a schematic diagram of a device constructed and arranged to carry out the improved techniques.

FIG. 2 is a schematic diagram of a graphical user interface (GUI) operative to display content within the applications running on the device illustrated in FIG. 1.

FIG. 3 is a diagram of a table stored in the device illustrated in FIG. 1 and which maps content to timestamps according to the improved techniques.

FIG. 4 is a schematic diagram of an electronic environment in which the device illustrated in FIG. 1 carries out the improved techniques.

FIG. 5 is a flow chart illustrating a method of carrying out the improved technique within the device illustrated in FIG. 1.

### DETAILED DESCRIPTION

Improved techniques involve invoking, within an application which supports a copy command, the copy command after selecting text in a transcript associated with video content. In response to the copy command, the application augments the selected text with a marker which corresponds, within the video content, to a particular video frame from which particular spoken text begins. The augmenting of the selected text occurs before the selected text is placed within a buffer in memory reserved for copied data. The contents of the buffer then include the selected text and the marker. The application further generates a URL link to a browser window containing a video player which is operable to play the video content starting at a particular location determined by the marker. Upon the issuing of a subsequent paste command within a content destination which includes a rich text environment, the selected text is pasted into the rich text environment. The pasted text includes a hyperlink which, when activated by clicking on the pasted text, launches a new browser window according to the URL link.

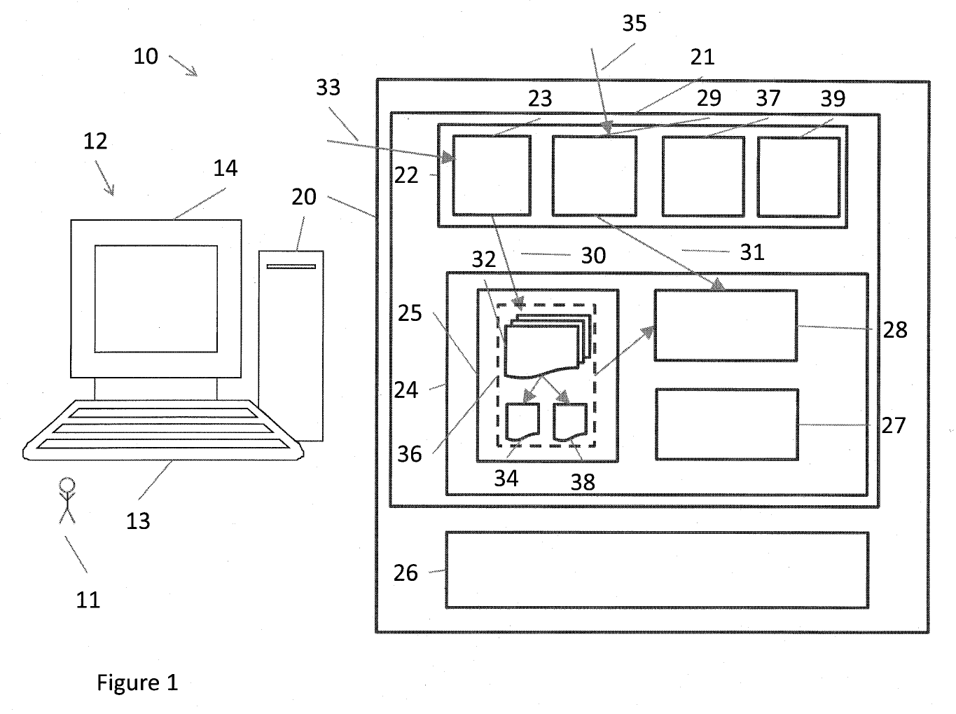

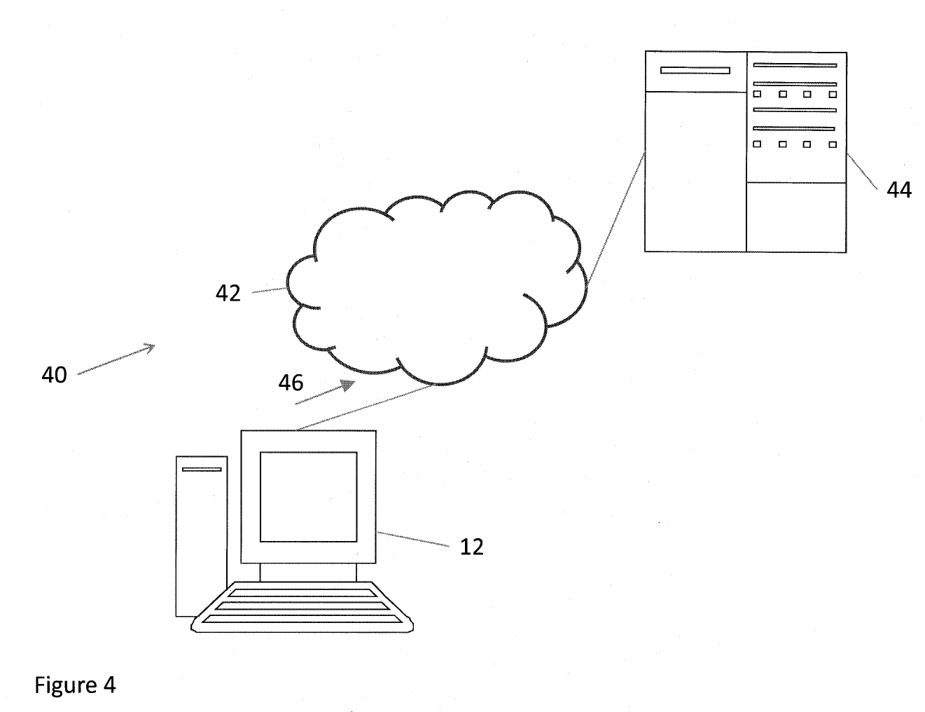

FIG. 1 shows an electronic environment 10 which is suitable for use by the improved technique. Electronic environment 10 includes a computer system 12, which in turn includes input assembly 13, electronic display 14 and computing unit 20 which includes a controller 21 and a network interface 26 which is constructed and arranged to electronically connect to a communications medium 42 (also see FIG. 4).

Computer system 12 can take the form of a personal computing system. Alternatively, computer system 12 can take a different form such as a smart phone, a personal digital assistant (PDA), a netbook, a tablet computer, a network computing system, etc.

The input assembly 13 is constructed and arranged to receive input from a user 11 of computer system 12 and convey that user input to the controller 21. Preferably, the input assembly 13 includes a keyboard to receive keystroke user input, and a directional apparatus (e.g., a mouse, touch pad, track ball, etc.) to receive mouse-style user input (e.g., absolute or relative pointer coordinates or similar location information) from user 11.

The keyboard of input assembly 13 is capable of issuing a copy command 33 within certain applications. For example, in many applications running within the Microsoft Windows™ operating system, a user 11 may issue a copy command 33 within a browser by inputting “CTRL-C” on the keyboard. Further, the mouse of input assembly 13 is capable of accessing a menu within an application to issue a copy command 33. For some computer systems, movement of the mouse to activate a “Copy” menu option has the same input effect as “CTRL-C”.

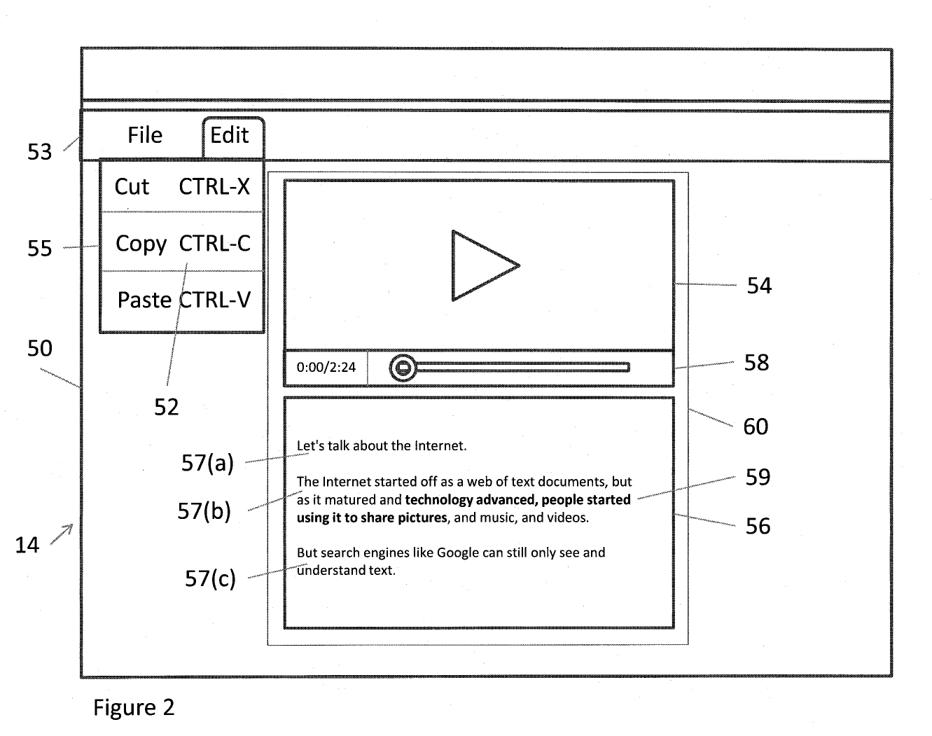

Electronic display 14 is constructed and arranged to provide, from controller 21 to user 11, graphical output which includes a graphical user interface (GUI) 50 (also see FIG. 2) within which an application operates. Accordingly, the electronic display 14 may include one or more computer (or television) monitors, or similar style graphical output devices (e.g., projectors, LCD or LED screens, and so on).

Controller 21 is constructed and arranged to perform operations in response to input from user 11 received through input assembly 13 and to provide output back to the user through electronic display 14. Controller 21 includes a processor 22 and memory 24 in order to run an operating system and user level applications. Controller 21 can take forms such as a motherboard, application-specific integrated circuits (ASICs), field programmable gate arrays (FPGAs), discrete components, etc.

Processor 22 is coupled to memory 24 and is constructed and arranged to carry out the improved techniques. Processor 22 specifically carries out the improved techniques by running starting point identification application 37 which identifies a starting point from which to render content in a content delivery session. Processor 22 is further constructed and arranged to run other applications such as content-based application 23, text-based application 29 and Internet browser application 39. Processor 22 can take the form of, but is not limited to, a processing circuit such as an Intel or AMD-based MPU, and can be a single or multi-core running single or multiple threads.

Content-based application 23 is constructed and arranged to run content player applications which render content from a content source 25. Content-based application 23 is also constructed and arranged to copy selected content portions from content sources to a buffer for pasting to content destinations in response to copy command 30. In some arrangements, content-based application 23 is an Internet browser. In other arrangements, however, content-based application is an application which supports a content player and copy commands.

Text-based application 29 includes a rich text environment and is constructed and arranged to insert data from the buffer into a text and supports hyperlinks.

Memory 24 is constructed and arranged to store code for content-based application 23, text-based application 29 and internet browser application 39 for execution by the processor 22. Memory 24 is further constructed and arranged to store code for starting point identification application 37. Memory 24 generally takes forms such as random access memory, flash memory, non-volatile memory, cache, etc. Memory 24 includes content source 25, content destination 27 and buffer 28.

Content source 25 includes locations in memory 24 constructed and arranged to provide content-based application 23 access to content portions 32 and associated data 34 and 38. For example, content portions 32 includes parts of a transcript containing text corresponding to spoken words in the video content. Associated data 34 and 38 take the form, respectively, of a marker associated with a particular content portion 32 and a URL link associated with content portions 32. Marker 34 identifies a starting point from which to render content portion 32 in a content delivery session.

Buffer 28 includes locations in memory 24 constructed and arranged to store data which has been copied from an application which supports copy commands.

Content destination 27 includes locations in memory 24 constructed and arranged to receive the data stored in buffer 28 in response to receipt of a paste command 31 entered in text-based application 29 running on processor 22.

During operation, while user 11 runs content-based application 23 on processor 22, user 11 selects a content portion 32. For example, content portion 32 is a portion of a transcript associated with video content rendered and displayed in a video player within browser application 23. While content portion 32 is selected, user 11 issues a copy command 33 within content-based application 23 which is constructed and arranged to instruct processor 22 to perform a copy operation 30, in response to receipt of copy command 33, on selected content portion 32. Copy operation 30 is constructed and arranged to make a copy of selected content portion 32 and move the copy from content source 25 to buffer 28. Before the copy of selected content portion 32 is moved to buffer 32, however, starting point identification application 37 instructs processor 22 to augment selected content portion 32 with marker 34 to form augmented content 36. Processor 22 is further instructed to augment selected content portion 32 with URL link 38 to add to augmented content 36. In this manner, copy operation 30 makes a copy of augmented content 36 and places the copy of augmented content 36 into buffer 28.

In this way, the improved technique allows for the identification of a starting point from which to render content in a content delivery session within any application, not necessarily an Internet browser, which supports a content player and a copy command 33.

It should be understood that some content-based applications 23 are capable of running scripting applications on processor 22. In some arrangements, starting point identification application 37 takes the form of a Javascript application which is downloaded into memory 24 by content-based application 23. The Javascript application is constructed and arranged to form augmented content 26 in response to receipt of copy command 33.

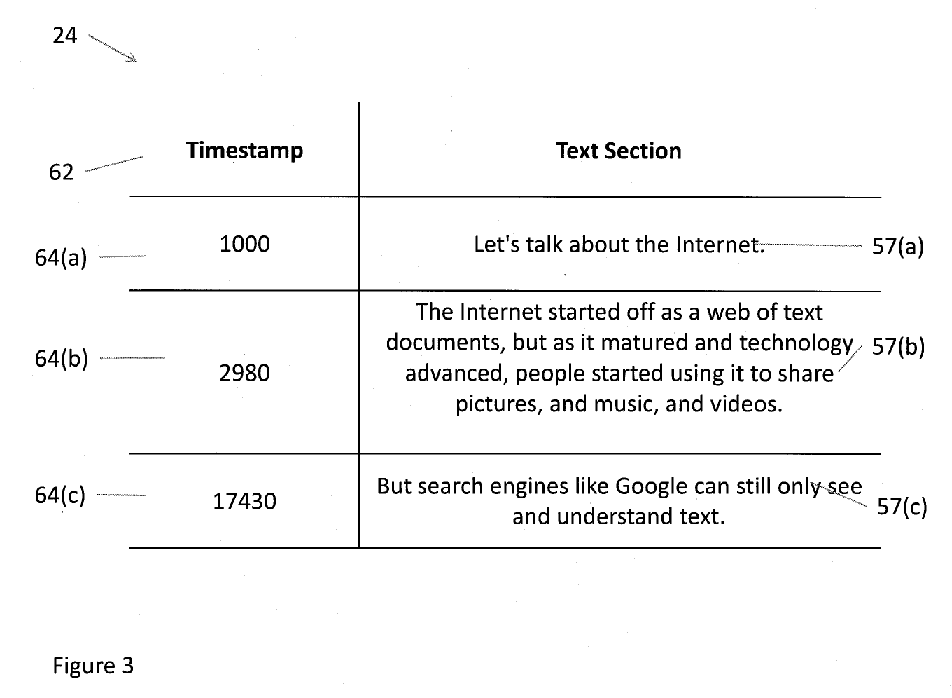

As described above, content portion 32 is, in some arrangements, a portion of a transcript associated with video content rendered and displayed in a video player within content-based application 23. Rendering and display of video content as well as content portions 32 on monitor 14 is described below with regard to FIG. 2 and FIG. 3 below.

FIG. 2 illustrates an example, using the improved techniques, of a rendering of content from content source 25 within a graphical user interface (GUI) 50 representing content-based application 23 on monitor 14. GUI 50 for content-based application 23 includes a menu bar 53 and an active area 60.

Menu bar 53 is constructed and arranged to provide facilities for user 11 to issue copy command 33 to controlling circuitry 22. Menu bar 53 includes an “Edit” field which, when activated by user 11 via input assembly 13, generates a drop-down menu 55. Drop-down menu 55 includes field 52 which, when activated by user 11 via input assembly 13, issues copy command 33 to processor 22.

Active area 60 is constructed and arranged to display rendered content from content source 25. Active area 60 includes video player 54 and transcript area 56.

Video player 54 is constructed and arranged to render video content from video files in content source 25. Video player 54 includes a time bar 56 which maps a time to a frame or set of frames of the video content. It is assumed that video content played in video player 54 includes spoken words.

Transcript area 56 contains a transcript which includes transcript text 59 corresponding to the spoken words of the video content. Transcript text 59 is broken into text captions 57(a), 57(b) and 57(c) (text captions 57). In the example illustrated in FIG. 2, each text caption 57 represents a sentence of the transcript; alternatively, a text caption 57 may include several sentences or a portion of a sentence. Each text caption corresponds to a particular marker which in the case of video content is a timestamp.

FIG. 3 illustrates a table 62 stored in memory 24 containing entries 64(a), 64(b) and 64(c) (entries 64), each of which map text captions 57(a), 57(b) and 57(c), respectively, to timestamps. Each timestamp corresponds to a time in the video player and a frame of the video content. The mapping is defined so that, when time bar 58 (also see FIG. 2) is set to a time to which a particular timestamp corresponds, the spoken words of the played video content correspond to the beginning of the text of the text caption which is mapped to the particular timestamp. For example, at the timestamp 2980 in entry 57(b), the video content begins playing the spoken words “The Internet . . . ”

from text caption 57(b).

During operation, user 11 selects, via input assembly 13, text within text caption 57(b). Upon receipt of copy command 33, processor 22 performs a lookup operation on table 62 to locate entry 64(b) which contains text caption 57(b) which includes the selected text. Processor 22 then places, as a marker, the timestamp (2980) to which text caption 57(b) is mapped into augmented content 36 which is placed into buffer 28.

As an example, consider the case illustrated in FIG. 2. User 11 selects the text “technology advanced, people started using it to share pictures” from transcript text 59. The beginning of the selected text lies within text caption 57(b). User 11 then issues copy command 33. Upon receipt of copy command 33, processor 22 performs a lookup operation on table 62 in memory 24, which lookup operation finds the timestamp 2980 to which text caption 57(b) is mapped. Video player 54 then begins playing the video content at the video frame at timestamp 2980. The video content then begins with the spoken words “The Internet started off . . . ” which are at the beginning of text caption 57(b).

Processor 22 also generates URL link 38 in response to receipt of copy command 33. Instructions for generating URL link 38 are contained in starting point identification application 37. URL link 38 is constructed and arranged to launch, upon activation, an Internet browser window within Internet browser application 39 containing a content player which renders the content in the content delivery session at the identified starting point. URL link 38 includes a code identifying a web server from which to render the content in a content delivery session and the timestamp to which the particular text caption corresponds. The identification of the web server is described in more detail with regard to FIG. 4 below.

A generic URL address, in some arrangements, takes the form
“http://www.<web address>.<generic top-level domain>/<key type><variable name>=<timestamp>”.

An example of a generated URL link 38 is taken from the example above:
“http://www.speakertext.com/?STQLSTEMBEDAPIKEY-5-pnNmdxMTqYxCp5xLBN9kigewIWoP9aTH=2980”

In this case, the portion “http://www.speakertext.com/” refers to the server to which a request for the content is sent. The portion “STQL” within the key type denotes the fact that the link was generated by starting point identification application 37 which performed the augmenting described above. The portion “STEMBED” denotes an instruction to embed the URL link 38 within a hyperlink in the pasted text as described below. The portion following “APIKEY” through to the “=” sign denotes auxiliary information including identifications of user 11 and computer system 12. The “2980” denotes the particular timestamp at which the video player is to begin playing the video.

Processor 22 also runs text-based application 29 which contains a rich text environment. User 11 issues a paste command 35 within application 29 after issuing copy command 33 within content-based application 23. In response to receipt of paste command 35, text-based application 29 instructs processor 22 to perform a paste operation 31 on buffer 28. Paste operation 31 is constructed and arranged to move the contents of buffer 28 to content destination 27. Moving contents of buffer 28 to content destination 27 causes text from selected content portion 32 to be inserted into a document within text-based application 29. Within the rich text environment of text-based application 29, the inserted text includes a hyperlink which, in response to a user performing a mouse click on the inserted text, launches a new browser window within Internet browser application 39 according to the URL link 38.

FIG. 4 illustrates an electronic environment 40 in which particular video content is downloaded onto a computer. Electronic environment includes computer system 12, communications medium 42 and remote server 44.

Communications medium 42 provides connections between computer system 12 and remote server 44. The communications medium 12 may implement a variety of protocols such as TCP/IP, UDP, ATM, Ethernet, Fibre Channel, combinations thereof, and the like. Furthermore, the communications medium 12 may include various components (e.g., cables, switches, gateways/bridges, NAS/SAN appliances/nodes, interfaces, etc.). Moreover, the communications medium 12 is capable of having a variety of topologies (e.g., hub-and-spoke, ring, backbone, multi-drop, point-to-point, irregular, combinations thereof, and so on).

Remote server 44 is constructed and arranged to receive requests for data which is rendered on a web page within Internet browser application 39 on computer system 12 via communication medium 42. Remote server 44 is further constructed and arranged to send the data upon receipt of the requests to computer system 12 via communication medium 42.

When user 11 activates, via input assembly 13, the hyperlink in the inserted text in text-based application 29, processor 22 sends, via network interface 26, a request 46 for video content to remote server 44 according to the generated URL 38. In response to receipt of request 46, remote server 44 sends data corresponding to video content to computer system 12 via network interface 26.

Activation of the hyperlink further causes a new Internet browser window to launch within Internet browser application 39. The new Internet browser window contains a video player which begins playing the downloaded video content at the video frame corresponding to the timestamp specified in the URL link 38.

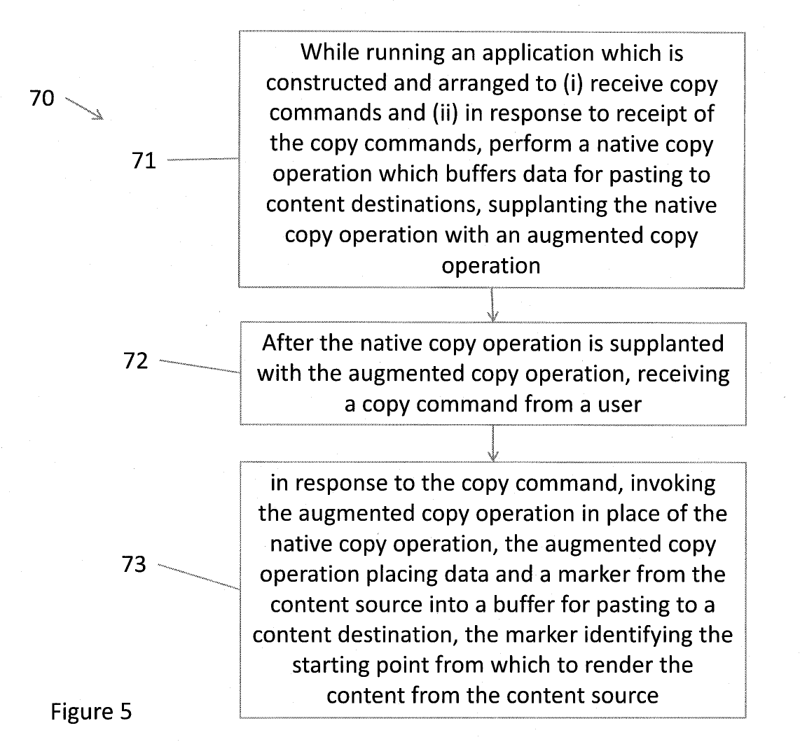

FIG. 5 illustrates a method 70 of identifying a starting point from which to render content in a content delivery session. In step 71, user input is received by a processing circuit while running an application on the processing circuit, the application being constructed and arranged to copy selected content portions from content sources to a buffer for pasting to content destinations in response to copy commands, the user input selecting a content portion from a content source. In step 72, a copy command is received while the content portion is selected. In step 73, in response to receipt of the copy command, augmented content which includes the selected content portion and a marker and copying the augmented content to the buffer for pasting to a content destination is formed, the marker identifying the starting point from which to render content in the content delivery session.

While various embodiments of the invention have been particularly shown and described, it will be understood by those skilled in the art that various changes in form and details may be made therein without departing from the spirit and scope of the invention as defined by the appended claims.

For example, the content described above can take the form of audio content. In this case, audio frames are defined within audio files such as those encoded with the MP3 standard. Each audio frame corresponds to a timestamp as with a video frame. Lookup tables for audio content follow a similar structure as illustrated by table 62 and lookup operations are identical to those described above for the case of video content.

Furthermore, it should be understood that some embodiments are directed to computer system 12 which identifies a starting point from which to render content in a content delivery session. Some embodiments are directed to computer system 12. Some embodiments are directed to a device which identifies a starting point from which to render content in a content delivery session. Some embodiments are directed to a process of identifying a starting point from which to render content in a content delivery session. Also, some embodiments are directed to a computer program product which enables computer logic to perform the identification of a starting point from which to render content in a content delivery session.

In some arrangements, computer system 12 is implemented by a set of processors or other types of control/processing circuitry running software. In such arrangements, the software instructions can be delivered to computer system 12 in the form of a computer program product (illustrated generally by code for starting point identification application 37 stored within memory 24 in FIG. 1) having a computer readable storage medium which stores the instructions in a non-volatile manner. Alternative examples of suitable computer readable storage media include tangible articles of manufacture and apparatus such as CD-ROM, flash memory, disk memory, tape memory, and the like.

What is claimed is:

1. A method of identifying a starting point from which to render content in a content delivery session, the method comprising:
while running an application on a processing circuit, the application being constructed and arranged to copy selected content portions from content sources to a buffer for pasting to content destinations in response to copy commands, receiving user input by the processing circuit, the user input selecting a content portion from a content source;
while the content portion is selected, receiving a copy command; and
in response to receipt of the copy command:
forming augmented content which includes the selected content portion and a marker, and
copying the augmented content to the buffer for pasting to a content destination, the marker identifying the starting point from which to render content in the content delivery session.

2. A method as in claim 1, wherein the content source includes a series of text captions, each text caption in the series of text captions corresponding to a respective timestamp;
wherein the user input selects, as the content portion, a particular text caption from the series of text captions; and
wherein forming the augmented content includes:
providing, as the marker which identifies the starting point from which to render content in the content delivery session, the respective timestamp to which the particular text caption corresponds.

3. A method as in claim 1, wherein the method further comprises:
generating and including within the augmented content a Uniform Resource Locator (URL) link which includes a code identifying a web server from which to render the content in the content delivery session and the timestamp to which the particular text caption corresponds;
wherein the URL link is constructed and arranged to launch, upon activation, an application which renders the content in the content delivery session at the identified starting point.

4. A method as in claim 1, wherein the method further comprises:
pasting the selected content portions into the content destination for subsequent access to the content.

5. A method as in claim 1, wherein the content source includes video content which includes a sequence of frames;
wherein the timestamp identifies a particular frame of the sequence of frames from which to begin rendering the video content; and
wherein the method further comprises:
rendering the video content at the particular frame identified by the timestamp.

6. A method as in claim 5, wherein a lookup table includes entries which map timestamps to particular frames of the sequence of frames; and
wherein rendering the video content at the particular frame identified by the timestamp includes:
performing a lookup operation on the lookup table to identify the particular frame of the video content, and
after performing the lookup operation, playing the video content starting at the particular frame of the video content.

7. A method as in claim 1, wherein the content source includes audio content which includes a sequence of frames;
wherein the timestamp identifies a particular frame of the sequence of frames from which to begin rendering the audio content; and
wherein the method further comprises:
rendering the audio content at the particular frame identified by the timestamp.

8. A method as in claim 7, wherein a lookup table includes entries which map timestamps to particular frames of the sequence of frames; and
wherein rendering the audio content at the particular frame identified by the timestamp includes:
performing a lookup operation on the lookup table to identify the particular frame of the audio content, and
after performing the lookup operation, playing the audio content starting at the particular frame of the audio content.

9. A method as in claim 1, wherein the application is a web browser which is equipped with a Javascript interpreter; and
wherein the method further comprises:
loading Javascript code by the web browser in response a webpage request, the Javascript code being constructed and arranged to form, in response to receipt of the copy command, the augmented content which includes the selected content portion and the marker.

10. A method as in claim 1 wherein receiving the copy command includes:
obtaining “CTRL-C” physical button press input from a keyboard operated by a user.

11. A device to identify a starting point from which to render content in a content delivery session, the device comprising:
a memory including a buffer; and
a controller which includes controlling circuitry coupled to the memory, the controlling circuitry being constructed and arranged to:
run an application which is stored in memory, the application being constructed and arranged to copy selected content portions from content sources to the buffer for pasting to content destinations in response to copy commands;
while running the application, receive user input, the user input selecting a content portion from a content source;
while the content portion is selected, receive a copy command; and
in response to receipt of the copy command:
form augmented content which includes the selected content portion and a marker, and
copy the augmented content to the buffer for pasting to a content destination, the marker identifying the starting point from which to render content in the content delivery session.

12. A device as in claim 11, wherein the content source includes a series of text captions, each text caption in the series of text captions corresponding to a respective timestamp;
wherein the user input selects, as the content portion, a particular text caption from the series of text captions; and
wherein forming the augmented content includes:
providing, as the marker which identifies the starting point from which to render content in the content delivery session, the respective timestamp to which the particular text caption corresponds.

13. A device as in claim 11, wherein the controlling circuitry is further constructed and arranged to:
generate and include within the augmented content a Uniform Resource Locator (URL) link which includes a code identifying a web server from which to render the content in the content delivery session and the timestamp to which the particular text caption corresponds;
wherein the URL link is constructed and arranged to launch, upon activation, an application which renders the content in the content delivery session at the identified starting point.

14. A device as in claim 11, wherein the controlling circuitry is further constructed and arranged to:
paste the selected content portions into the content destination for subsequent access to the content.

15. A device as in claim 11, wherein the content source includes video content which includes a sequence of frames;
wherein the timestamp identifies a particular frame of the sequence of frames from which to begin rendering the video content; and
wherein the method further comprises:
rendering the video content at the particular frame identified by the timestamp.

16. A device as in claim 15, wherein a lookup table includes entries which map timestamps to particular frames of the sequence of frames; and
wherein rendering the video content at the particular frame identified by the timestamp includes:
performing a lookup operation on the lookup table to identify the particular frame of the video content, and
after performing the lookup operation, playing the video content starting at the particular frame of the video content.

17. A computer program product having a non-transitory computer readable storage medium which stores a set of instructions to identify a starting point from which to render content in a content delivery session, the set of instructions, when carried out by a computer, causing the computer to:
run an application which is stored in memory, the application being constructed and arranged to copy selected content portions from content sources to the buffer for pasting to content destinations in response to copy commands;
while running the application, receive user input, the user input selecting a content portion from a content source;
while the content portion is selected, receive a copy command; and
in response to receipt of the copy command:
form augmented content which includes the selected content portion and a marker, and
copy the augmented content to the buffer for pasting to a content destination, the marker identifying the starting point from which to render content in the content delivery session.

18. A computer program product as in claim 17, wherein the content source includes a series of text captions, each text caption in the series of text captions corresponding to a respective timestamp;
wherein the user input selects, as the content portion, a particular text caption from the series of text captions; and
wherein forming the augmented content includes:
providing, as the marker which identifies the starting point from which to render content in the content delivery session, the respective timestamp to which the particular text caption corresponds.

19. A computer program product as in claim 18, wherein the set of instructions further cause the computer to:
generate and include within the augmented content a Uniform Resource Locator (URL) link which includes a code identifying a web server from which to render the content in the content delivery session and the timestamp to which the particular text caption corresponds;
wherein the URL link is constructed and arranged to launch, upon activation, an application which renders the content in the content delivery session at the identified starting point.

20. A computer program product as in claim 19, wherein the set of instructions further cause the computer to:
paste the selected content portions into the content destination for subsequent access to the content.
